(19) United States
(12) Patent Application Publication
(10) Pub. No.: US 2008/0138788 A1
(43) Pub. Date: Jun. 12, 2008

(54) ADAPTIVE AND INDIVIDUAL LEARNING WITH FEEDBACK FOR ONLINE COURSES

(76) Inventors: Curtis Dell Allen, Provo, UT (US); Brandt Christian Redd, Provo, UT (US); James Russell Ivie, Lindon, UT (US); Mark Wolfgramm, Provo, UT (US); Brady S. Isom, Pleasant Grove, UT (US); Jeffery R. Gammon, Pleasant Grove, UT (US); Bernd Helzer, Draper, UT (US); Todd J. Hardman, Orem, UT (US); Paul Bryon Smith, Lehi, UT (US); Jiaxin Jerry Gao, Lehi, UT (US)

Correspondence Address: WORKMAN NYDEGGER, 60 EAST SOUTH TEMPLE, 1000 EAGLE GATE TOWER, SALT LAKE CITY, UT, 84111, US

(21) Appl. No.: 11/851,328

(22) Filed: Sep. 6, 2007

Related U.S. Application Data
(60) Provisional application No. 60/824,750, filed on Sep. 6, 2006.

(51) Int. Cl. G09B 5/14

(52) U.S. Cl. 434/365

(57) ABSTRACT

A method and system for creating a customized curriculum for a student in an online system is disclosed. The method and system include creating course objectives that correlate with course materials for an online course. The course objectives include a value stored on an educational management system. A parameter is set and associated with the course objectives. The parameter includes a value, and is stored on the educational management system. The student is given an assessment evaluation and the outcome of the student's performance on the assessment evaluation is tracked. The outcome is compared to the course objectives to provide comparison data. The comparison data is used to create a customized curriculum. The customized curriculum comprised of course materials are stored on the educational management system and are distributed to the user through a network connection.

### CROSS-REFERENCE TO RELATED APPLICATIONS

This application claims the benefit of U.S. Provisional Patent Application No. 60/824,750, filed on Sep. 6, 2006, which is hereby incorporated by reference.

### BACKGROUND OF THE INVENTION

1. The Field of the Invention

The invention generally relates to online systems for educational course materials, and more particularly, to systems for adapting and personalizing online courses for individual users.

2. The Relevant Technology

Educators are constantly looking for new tools to help them teach more efficiently and effectively. Web-based learning management systems (LMS) and content management systems (CMS) have been increasingly used by corporations, government agencies, and higher education institutions. A LMS is a software package that facilitates the management and delivery of online content to learners, often in order to enable the individualized and flexible access to learning content. Typically, an LMS allows for an online teaching environment, which a CMS is a computer software system that is typically used to manage the storing, controlling, versioning, and publishing of the educational content. Using a combination of the above technologies, several educational systems have been developed in the art that offer flexible online learning solutions for educators.

Due to the flexible and individualized nature of the systems, students and employees can take courses on their own time and at their own pace, in accordance with their various daily commitments, while educators, management, and human resource departments are able to track progress. Further, because the systems may be easily updated and modified, the systems often provide more relevant information than is currently available using traditional teaching tools.

One advantage of these courses is the ability to give students key information they need outside the confines of the traditional university buildings or classrooms. The distance learning students can gain access to the course materials by connecting to the Internet or other global network. Thus, several institutions have implemented online or hybrid courses where the course is administered wholly or partially in the online setting.

Despite these attempts to create a learning environment that is custom-tailored for the student, the systems use traditional methods to create generic course content that is used for each student, despite the student's skill or understanding. One difficulty in the traditional model of course and curriculum development is that the system fails to create a personalized learning environment. Thus, students who are struggling with a course are given the same assignments and materials as students who are excelling. Without the ability to create assignments or other course materials that is specifically designed to address the students, many teachers are unable to effectively teach students. The students whose understanding falls below the average student are not given the extra attention and instruction that they need and students who are excelling in a course are not adequately challenged.

One goal of today's educational systems is to develop a completely individualized or personalized learning environment, wherein students receive instruction that is custom-tailored so that the student is adequately challenged with new and interesting material, without overwhelming the student with material that he or she does not understand. This task is difficult, if not impossible, in the traditional classroom setting, where teachers' limited time and attention must be directed to an entire classroom full of students simultaneously. Without better tools to assess and supply students with customized course materials, it is often too difficult for teachers to adequately challenge and guide each student at the appropriate level.

Thus there is a need for an educational system that utilizes the technological resources and advantages of an online system in order to create an individualized or adaptive learning environment that enables each student to receive personalized instruction.

### BRIEF SUMMARY OF THE INVENTION

The invention generally relates to online systems for educational course materials, and more particularly, to systems for adapting and personalizing online courses for individual users.

A method creates a customized course curriculum of course materials in a computing environment for online courses. The method includes creating course objectives that correlate with course materials for an online course. The course objectives include a value stored on an educational management system. The method sets a parameter for the course objectives and associates the parameter with the value. The parameter is stored on the educational management system. The student is given an assessment evaluation. The outcome of the assessment evaluation is tracked and stored in the educational management system. The outcome includes a grade associated with the student and is compared to course objectives to provide comparison data. Using the comparison data, the system is able go generate a customized curriculum comprised of course materials that correlate with course objectives. The course materials are distributed from the educational management system to a user's computer through a network connection.

In another aspect of the invention, a system creates a customized course curriculum for a user in a computing environment for online courses. The system includes a content provider having course materials and an assessment evaluation for an online course to be accessed by a user's computer. The system includes an educational management system having a server and a database. The educational management system is configured to associate data with the course materials and correlate course objectives with the course materials and assessment evaluation. The course materials have a value. The educational management system includes parameters set for the course objectives, which are associated with the value. The educational management system transfers an assessment evaluation to the user, the assessment evaluation including data corresponding to various course objectives. The outcome of a student's performance on the assessment evaluation is stored on the server and includes a grade associated with the student. The outcome is compared to the course objectives to provide comparison data, which is stored on the server, and used to generate a personalized curriculum comprised of course materials. The system includes a network connection linked to the educational management system and configured to distribute the course materials from the content provider to the user's computer. The network connection provides a link to transfer information between the educational management system and the user's computer. The information transferred between the educational management system and the user's computer is associated with a particular online course and user in the database.

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

These and other aspects of the present invention along with additional features and advantages will be set forth in the description that follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGS. 1A-B are block diagrams illustrating an exemplary system capable of performing the invention;

FIG. 2 is a block diagram illustrating the method of the present invention;

FIG. 3 is a block diagram illustrating a method of generating a customized curriculum according to the embodiments of the present invention; and

FIG. 4 is a block diagram illustrating a method of generating a customized curriculum according to the embodiments of the present invention.

### DETAILED DESCRIPTION OF THE VARIOUS EMBODIMENTS

The principles of the various embodiments are described using the structure and operation of examples to illustrate the present invention. The various embodiments provide the capability to utilize the assessment aspects of the online courses with no or intermittent Internet access and enables the periodic synchronization of information, such as course materials, tests, bulletin boards, grade books, quizzes, discussion threads, message boards, and the like.

As used herein, the term “user” may be used to describe students, employees, content providers, educators, employers, or course administrators who are accessing the education management system using a computer. The computer may be any specific of general computer system that is equipped to receive, send, and process educational content. The computer may be, for example, a personal computer, portable computer, handheld device, or any other computing machine. A suitable computer system may include a modem, a monitor, a keyboard, a mouse, system software including support for TCP/IP communication, and other various types of software. Further, more than one user may connect to the education management system using the same computer.

In each case, the distributed nature of the present invention allows the various users to utilize aspects of the educational system while offline, meaning that the users may continue working regardless of their present interconnectivity. As discussed more specifically below, the system operates by distributing various learning software onto the user computer when the user is connected to the system, wherein the learning software continues being used when the user is no longer connected to the system. Later, when the user connects to the system, the user's computer and the educational system perform a syncing operation. During the syncing operation, the educational system receives any work or new data that has been created or modified while the user's computer was offline and the user's computer receives any new information or data available on the educational system.

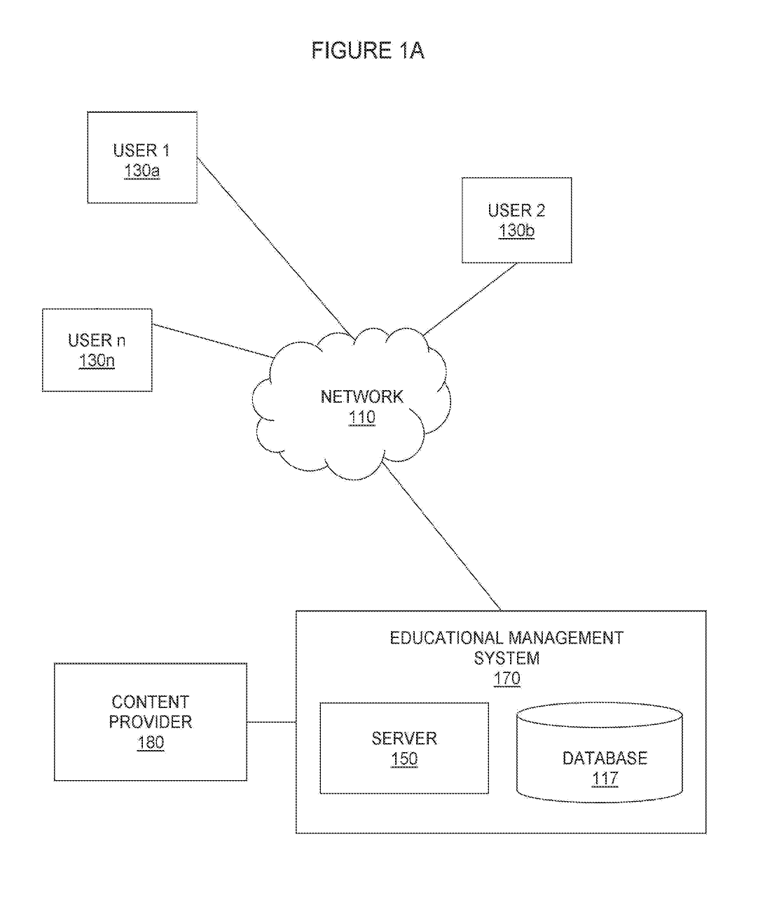

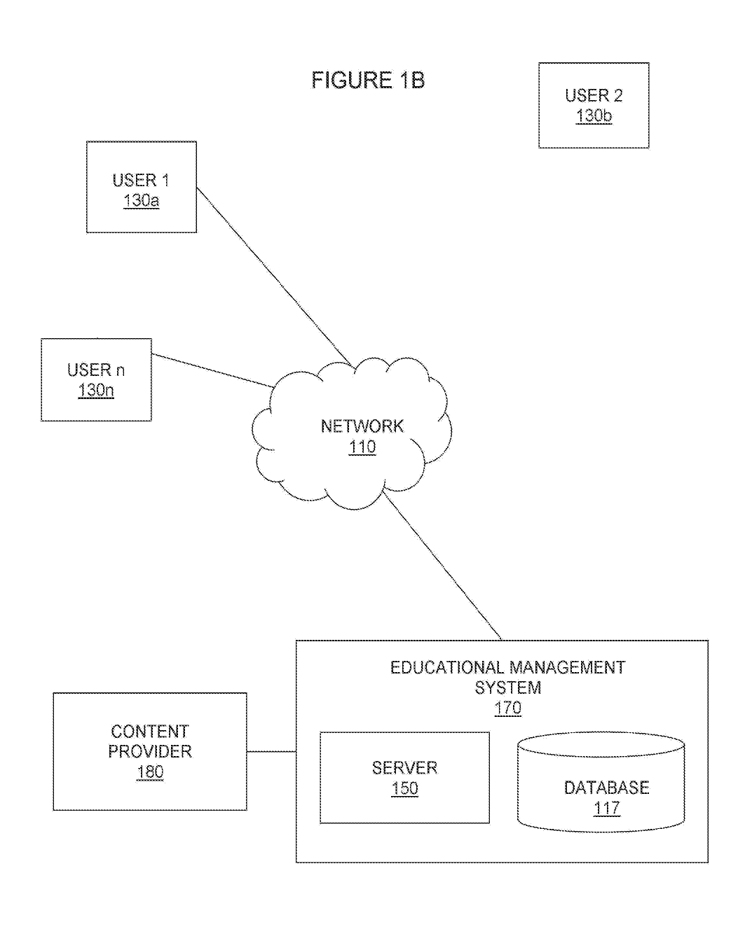

FIG. 1A is a block diagram illustrating an exemplary system capable of performing the present invention. As shown, the system includes a number of users, “User 1” 130a through “User n” 130n, who are connected to an educational management system 170 via a network connection 120. As will be understood by one of ordinary skill in the art, the network 120 may be any local or global network, including a LAN, WAN, wireless network, internet connection, and the like.

In one embodiment of the invention, the education management system 170 includes a server 150 capable of sending and receiving communications and data via the network 120, along with a database 160 capable of storing a plurality of educational software and data. In addition, the database 160 can be used to store data relating to the user identification. As will be understood by one of ordinary skill in the art, any number of configurations may be used to create an education system, including systems using a series of interconnected databases, computers, and servers.

In this example, the education management system 170 is connected to a content provider 180. Here, the content provider 180 may be a third party content provider, who is responsible for creating various course software. In contrast, the content provider 180 may be part of the education management system 170. Further, the content provider 180 may be an educator or course developer who connects to the education management system 170 as a user.

According to one embodiment of the present invention, the system may use a mechanism such as a bit torrent or related protocol wherein the system may use a peer-to-peer communications protocol to share the educational content. Using such systems, the system typically breaks down any content into a number of smaller, identically-sized pieces, which are distributed among a plurality of users of the system who require the educational content. Then using a series of P2P connections, the files may be sent and received by the users over a period of time. Advantageously, this method of distribution is capable of distributing large amounts of data widely without requiring the content provider 180 or server 150 to incur the large costs of hardware, hosting, and bandwidth resources that would otherwise be required to distribute the educational content. Further, this embodiment would allow the “trickling” of downloads, meaning that in situations where the content to be downloaded is a large file, the system may permit the user to download smaller discrete portions of the content, instead of requiring a constant connection for the duration of the downloading process. A scheduled download can populate the user's computers with course content over a controlled distribution.

Thus, in situations where a large number of identical files need to be distributed to a number of users of the system, say at the beginning of a semester or session, when each student of the program requires the content associated with the course, the present invention may be effectively distributed without overwhelming the education management system 170.

FIG. 1B illustrates the ability of the present invention to be used when a user, here “User 2” 130b is no longer connected to the education management system 170. As described more fully below, one advantage of the present invention is the ability to transfer or distribute software and/or data onto “User 2's” 130b computer which enable “User 2” 130b to continue using the educational software when the computer is not connected to the management system 170. According to the invention, when “User 2” 130b later establishes a connection with the educational management system 170, such as the connection shown in FIG. 1A, the system 170 will perform a syncing operation, wherein it will send and receive data from the “User 2” computer 130b until both the system 170 and the “User 2” 130b have updated information.

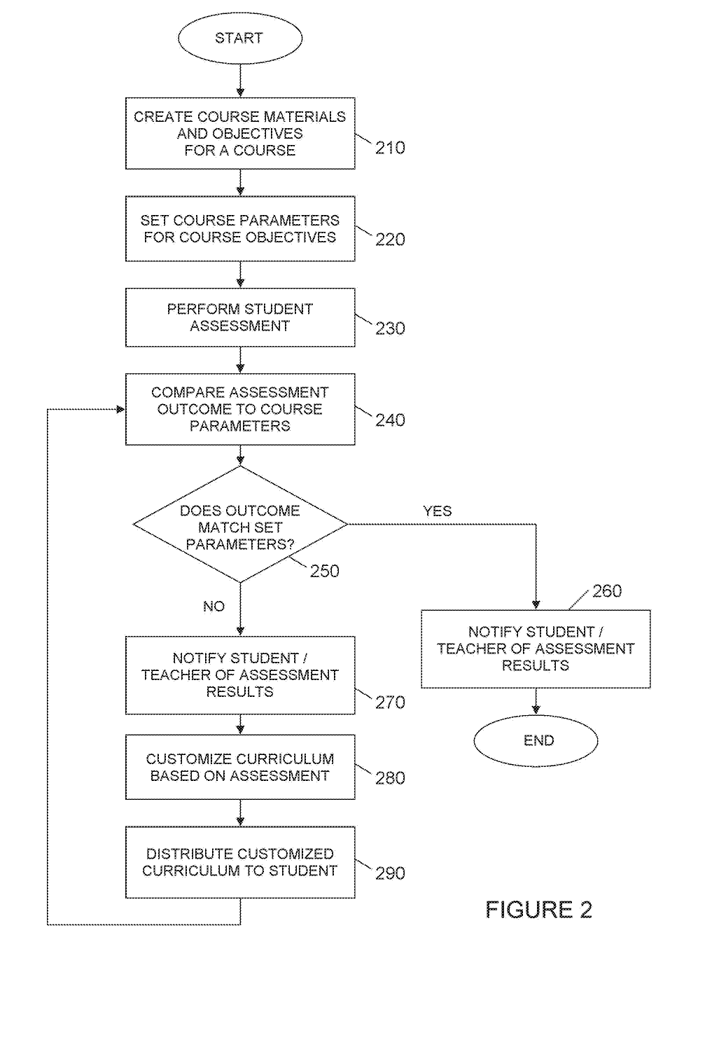

FIG. 2 is a block diagram illustrating a process 200 for performing the present invention in a networked computer environment. At step 210, course materials and objectives are created for a particular course and stored in the education management system. The course objectives are assigned values, such as numbers 0 through 100, letters, pass/fail, topic expressions, and the like, to be compared to the student's assessed performance. At step 220, parameters are set for course objectives. A parameter, for instance, can be selected based on an exemplary student's performance on an assessment test, meaning that the parameter will be deemed to be the performance of a typical student who has sufficiently mastered a particular course objective. Thus, the parameter may be used to determine whether a student has sufficiently mastered a particular course objective by comparing the student's assessment performance with the parameter.

The parameter may include a Boolean expression, such as >, <, =, not, or any combination thereof By way of an example, an educator may determine that any student who receives a score of >=80 percent on all questions relating to a particular objective on an assessment test has demonstrated an adequate mastery of the objective. Thus, if the student receives a sore higher than 80 percent, then the student will be deemed to have mastered the learning objective.

At step 230, the system administers a student assessment. Generally the student assessment is test, quiz, or similar evaluation mechanism that measures the student's understanding and mastery of a particular course objective or group of course objectives. The student's performance may be measured, for example, in the number of correct answers, letter grade, percentage, pass/fail expression or other methods typically used in the educational system and can be weighted to meet a specific course emphasis for the course. As may be understood by one of ordinary skill in the art, a single assessment test may be used to determine a student's knowledge of a plurality of learning objectives for a particular course or series of courses.

The student's performance is then stored in the system, and at step 240, the student's performance or assessment outcome is compared to course parameters to provide comparison data. The comparison data can be stored in memory, such as in the database or on the server of the educational management system. If the outcome meets the set parameters in step 250, then the student is deemed to already know the course objectives for the course. The system notifies the teacher, the student, or parent that the student already has a mastery of the learning objectives, and the process ends without the system creating any curriculum for the student.

If at step 250, it is determined that the outcome of the student's assessment is below or does not match the set parameters, then at step 270 the system creates a personalized curriculum for the student based on the outcome. Examples of methods of developing the personalized curriculum will be discussed more fully below. At step 280, the system notifies the teacher, student, or parent of the results of the assessment outcome. Using this feedback mechanism, the system is able to notify the student, teacher, and parent of the areas that the student has and has not mastered. Advantageously, this allows the teacher and parent to identify the areas that the student needs additional help, and alerts the student to the areas that need the most work.

At step 290, the system distributes the customized curriculum through a network connection, preferably using the distributed system described in FIGS. 1A and 1B, and the process continues from step 230. Using this system, the system continues to generate customized content for the student until the student demonstrates a sufficient mastery of the subject. Advantageously, this allows students to continue to work on a topic until they have fully grasped the concepts, rather than forcing them to move on to the next topic simply because the majority of their classmates are ready to do so.

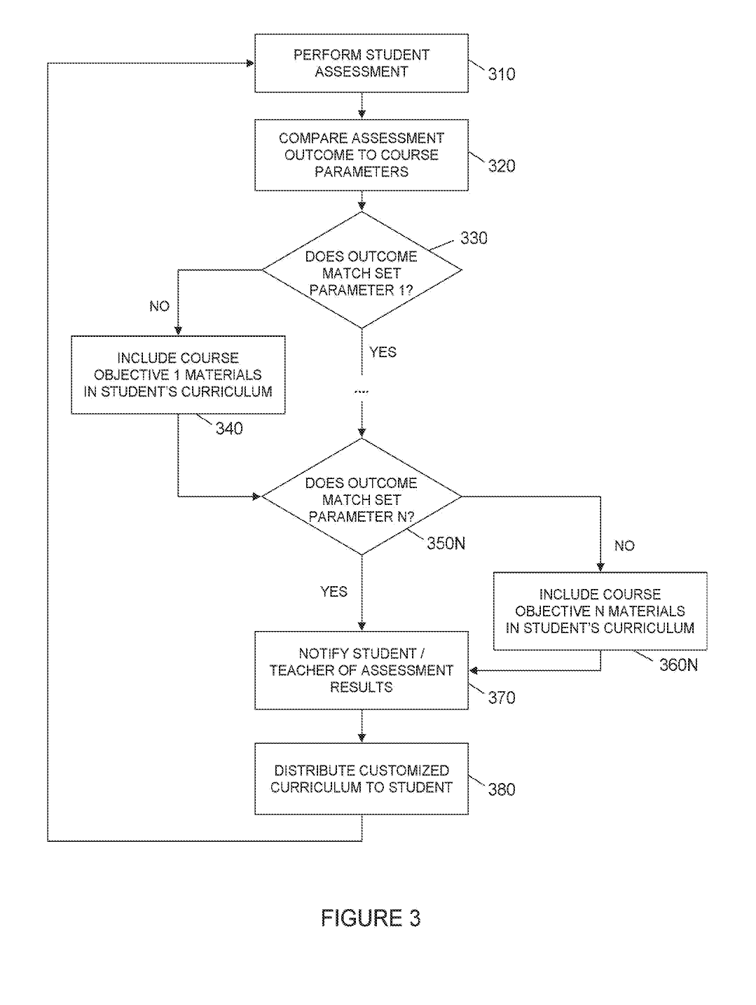

FIG. 3 illustrates an exemplary process of developing the personalized curriculum for 1-n different course objectives for a course, each course objective having a set parameter, parameter 1-n, respectively. Similar to the method described in FIG. 2, at step 310, the student's performance is assessed, using a test or similar method. Using the outcome of the student assessment, at step 320 the student's performance or assessment outcome on portions of the assessment relating to course objective 1 is compared to course parameter 1 to provide comparison data, to determine whether the student has displayed a mastery of course objective 1. The comparison data can be stored in memory, such as in the database or on the server of the educational management system. If at step 330 it is determined that the student has displayed a mastery of course objective 1, the system does not include course content related to course objective 1 in the student's course curriculum and proceeds to step 350N. If at step 330 the student does not display a mastery of course objective 1, then at step 340, the system includes the course materials relating to course objective 1 in the personalized curriculum.

The system repeats this process for each of the course objectives 2-n. At step 350N the system compares the outcome on of the student's assessment on portions of the assessment relating to course objective n and compares it to course parameter n to provide comparison data, to determine whether the student has displayed a mastery of course objective n. The system then either the system adds course material relating to course objective n to the personalized curriculum at step 360N, or the system proceeds to the next step. After each determination, the system stores the comparison data and data relating to the personalized curriculum in the server or database of the educational management. After this process is completed for each one of the 1-n course objectives, then at step 370 the system then notifies the student, teacher, and optionally the parent of the results of the student's assessment and of the contents of the personalized curriculum. Then at step 380, the personalized curriculum is distributed to the student, preferably using the distributed learning environment described in FIGS. 1A and 1B. After the student receives the curriculum and completes it, then the process starts over at step 310.

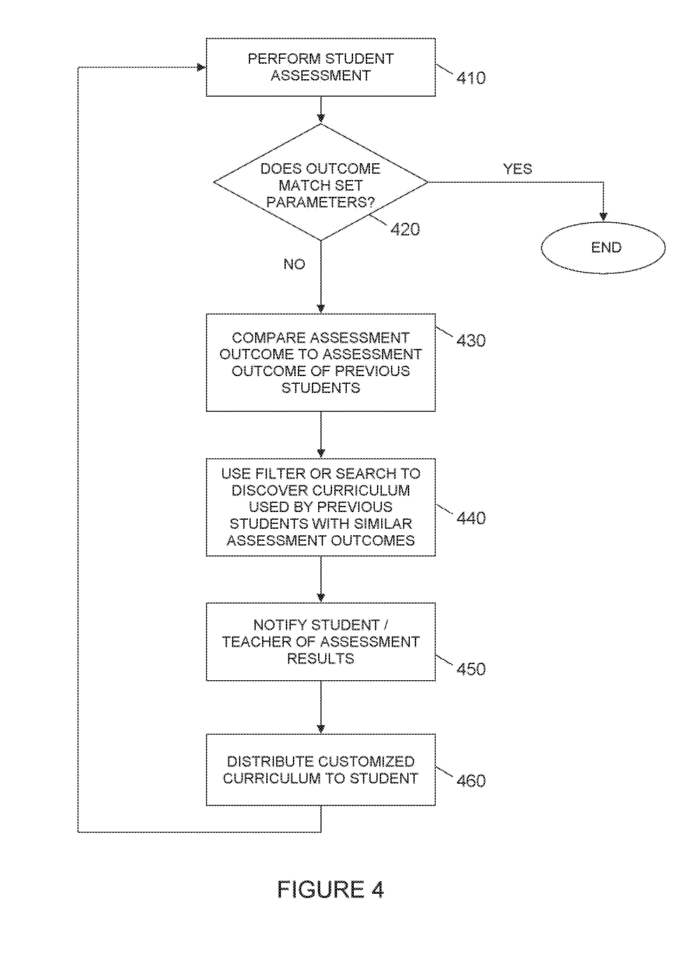

FIG. 4 illustrates another exemplary process of developing the personalized curriculum in conjunction with the present invention. At step 410, the student is assessed. At step 420, the assessment outcome is compared to set parameters. If the assessment outcome is determined to be greater or equal to set parameters, then comparison data is stored in the education management system and the process ends. If at step 420 it is determined that the assessment outcome does not match set parameters, then at step 430 the assessment outcome is compared to assessment outcomes of previous students which are stored in the system. Using the comparison data generated in step 430, then at step 440, the system creates a personalized curriculum by filtering or searching to the education management server or database to find data from other students with similar assessment outcomes and recovering their course content. Once the curriculum is created at step 440, then at step 450 the system notifies both the student and the teacher of the results. At step 460 the curriculum is distributed to the student and the process begins again at step 410.

Thus one aspect of the embodiment illustrated in FIG. 4 is the use of a search or filtering system to discover other students who have received similar outcomes on the assessment evaluation. The search or filtering system may be a collaborative filter, content-based filter, or any other filtering system known in the art. Although such systems differ in their particular embodiments, it should be understand that any search mechanism that uses the comparison data for a student to discover other students with similar comparison data is suitable for use in accordance with the present invention. Advantageously, this embodiment of the invention allows teachers to use course materials and content that has previously been used to effectively teach the course material to a student who is having the same difficulties as previous students.

Thus, if student 1 receives a score on the assessment evaluation indicating that he or she does not fully understand learning objectives A, C, and D, but does fully understand learning objectives B, E, and F, the system may perform a search to discover what educational materials were useful to other students 2 and 4 who received the same or similar outcome on the assessment evaluation. Then the system may retrieve the course materials used by students 2 and 4 to create a curriculum for student 1.

Embodiments of the present invention may include or be conducted using a special purpose or general-purpose computer, processor, or logic device including various computer hardware and devices, as discussed in greater detail herein or known to one of ordinary skill. Embodiments within the scope of the present invention can also include computer-readable media for carrying or having computer-executable instructions or data structures stored thereon. Such computer-readable media can be any available media that can be accessed by a general purpose computer, special purpose computer, or a logic device. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose computer, special purpose computer, or other logic device.

When information is transferred or provided over a network or other communication connection (either hardwired, wireless, or a combination of hardwired or wireless) to a computer, the computer can properly view the connection as a computer-readable medium. Thus, any such connection is properly termed a computer-readable medium. Various combinations of the above should also be included within the scope of computer-readable media. Computer-executable instructions comprise, for example, instructions, logic, and data which cause a general purpose computer, special purpose computer, or logic device to perform a certain function or group of functions.

Each of the processors described herein can be a single conventional general purpose computer, special purpose computer, or logic device, or each processor can be multiple processors including multiple conventional general purpose computer, special purpose computers, or multiple logic devices. Moreover, many of the functions that take place using a processor can be implemented on other types of logic devices, such as programmable logic devices. In addition, additional processors, logic devices, or hardware may be implemented to carry out a given function or step according to additional embodiments of the present invention. For example, additional processors may be implemented for storage and retrieval of data as is known to one of ordinary skill in the art. Such details have been eliminated so as to not obscure the invention by detail.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment for online courses, a method for creating a customized curriculum for a student, the method comprising:
creating course objectives that correlate with course materials for an online course, the course objectives including a value stored on an educational management system;
setting a parameter for the course objectives and associating the parameter with the value, the parameter being stored on the educational management system;
performing an assessment evaluation of a student, the assessment evaluation correlating to the course objectives of the online course;
tracking the outcome of a student's performance on the assessment evaluation;
comparing the outcome to the course objectives to provide comparison data, the comparison data being stored on the educational management system;
creating a customized curriculum for the student based on the comparison data, the customized curriculum comprised of course materials; and
distributing the course materials from the educational management system to a user's computer through a network connection.

2. The method of claim 1, wherein the step of creating course objectives includes assigning values to define an expected score for a student with an acceptable mastery of the course objectives.

3. The method of claim 2, wherein assessment evaluation of the student comprises a course assignment, quiz, test, or project.

4. The method of claim 2, wherein the step of setting the parameter includes defining a parameter associated with the objectives having a Boolean expression including at least one of >, <, =, and not.

5. The method of claim 1, wherein the step of tracking the outcome includes storing at least one of a number of correct answers, letter grade, percentage and pass/fail expression.

6. The method of claim 5, wherein the step of tracking the outcome includes an outcome that is weighted to meet a specific course emphasis for the online course.

7. The method of claim 1, wherein the step of tracking the outcome includes tallying the outcome for all students enrolled in the online course.

8. The method of claim 1, further comprising notifying the student of the of the comparison data.

9. The method of claim 1, wherein creating a customized curriculum for the student comprises using comparison data to discover the curriculum of previous students with similar outcomes.

10. The method of claim 1, further comprising displaying the values in at least one of a numerical form and a graphical form.

11. The method of claim 1, further comprising displaying the comparison data in at least one of a numerical form and a graphical form.

12. A system for creating a customized curriculum for a student in a computing environment for online courses, the system comprising:
a content provider including course materials for an online course to be accessed by a user's computer;
an educational management system including a server and a database, the educational management system being configured to associate data with the course materials and correlate course objectives with the course materials, the educational management system including parameters set for the course objectives and associated with the value; and
a network connection linked to the educational management system and configured to distribute the course materials from the content provider to the user's computer, the network connection providing a link to transfer information between the educational management system and the user's computer,
wherein the information transferred between the educational management system and the user's computer is associated with a particular online course and user in the database, the outcome of a student's performance on an assessment is stored on the server, the outcome includes a grade associated with the student, the outcome is compared to the course objectives to provide comparison data stored on the server, and the comparison data is used to generate a customized curriculum for a user comprised of course materials.

13. The system of claim 12, wherein the educational management system assigns values related to the course objectives to define n expected score for a user with an acceptable mastery of the course objectives.

14. The system of claim 12, wherein the parameter is associated with the objectives having a Boolean expression including at least one of >, <, =, and not.

15. The system of claim 12, wherein the educational management system is configured to search previous users of the system according to comparison data for a particular online course and distribute the course materials of the previous users to other users with similar comparison data for the online course.

16. The system of claim 12, wherein the educational system is configured to transfer data to a user to display the values in at least one of a numerical form and a graphical form.

17. The system of claim 12, wherein the educational system is configured to transfer data to a user to display the comparison data in at least one of a numerical form and a graphical form.

18. In a computing environment for online courses, a method for creating a customized curriculum for a student, the method comprising:
creating a plurality of course objectives that correlate with course materials for an online course, the plurality of course objectives including a value stored on an educational management system;
setting a parameter for each of the plurality of course objectives and associating each parameter with a value, the parameters being stored on the educational management system;
performing an assessment evaluation of a student, the assessment evaluation including data correlating to each of the course objectives of the online course;
tracking the outcome of a student's performance on the assessment evaluation;
comparing the outcome to each of the course objectives to provide comparison data, the comparison data being stored on the educational management system;
creating a customized curriculum for the student based on the comparison data for each of the course objectives, the customized curriculum comprised of course materials which correlate with course objectives; and
distributing the course materials from the educational management system to a user's computer through a network connection.

19. The method of claim 18, wherein the step of creating course objectives includes assigning values to define an expected score for a student with an acceptable mastery of the course objective.

20. The method of claim 19, wherein assessment evaluation of the student comprises a course assignment, quiz, test, or project.

21. The method of claim 19, wherein the step of setting the parameter includes defining a parameter associated with the objectives having a Boolean expression including at least one of >, <, =, and not.

22. The method of claim 18, wherein the step of tracking the outcome includes storing at least one of a number of correct answers, letter grade, percentage and pass/fail expression.

23. The method of claim 18, further comprising notifying the student of the of the comparison data.

24. The method of claim 18, further comprising displaying the values in at least one of a numerical form and a graphical form.

25. The method of claim 18, further comprising displaying the comparison data in at least one of a numerical form and a graphical form.
